(19) United States
(12) Patent Application Publication
(10) Pub. No.: US 2009/0225882 A1
(43) Pub. Date: Sep. 10, 2009

(54) DETECTING METHOD AND DETECTING CIRCUIT

(75) Inventor: Masahiro YOSHIDA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/398,849

(22) Filed: Mar. 5, 2009

(30) Foreign Application Priority Data
Mar. 6, 2008 (JP) 2008-056436

(51) Int. Cl. H04L 27/28

(52) U.S. Cl. 375/260

(57) ABSTRACT

A detecting circuit for receiving an Orthogonal Frequency Division Multiplexing (OFDM) signal modulated by Binary Phase Shift Keying (BPSK) and detecting a predetermined symbol in the OFDM signal is disclosed. The detecting circuit includes a correlation calculating part configured to obtain a correlation value between a first part of the OFDM signal and an inverted signal obtained by a second part of the OFDM signal corresponding to the first part and a detecting part configured to detect the predetermined symbol based on the correlation value obtained by the correlation calculating part.

### BACKGROUND OF THE INVENTION

1. Field of the Invention

The present invention generally relates to a detecting method and a detecting circuit for detecting transmitted predetermined signals where the transmitted predetermined signals are modulated into Orthogonal Frequency Division Multiplexing (OFDM) by Binary Phase Shift Keying (BPSK).

2. Description of the Related Art

A wireless communications technology referred to as IEEE 802.16 has been gaining attention in recent years. IEEE 802.16 is a technology for establishing connections between communication common carriers and user residences via a wireless Metropolitan Area Network (a wide area network connecting local area networks (LAN) in urban areas or specific regions, hereinafter also referred to as “MAN”), instead of using, for example, telephone lines or optical fiber lines. The IEEE 802.16 technology allows a single wireless base station to cover an area having a radius of approximately 50 km with a maximum transmission rate of 70 megabits/second.

In the IEEE 802.16 Working Group, this technology is referred to as WiMAX (Worldwide Interoperability for Microwave Access) and is developed as a Point-to-Multipoint (P-MP) communications method allowing plural terminals to be connected to a wireless base station. The IEEE 802.16 technology includes the IEEE 802.16d standard used mainly for fixed communications and the IEEE 802.16e standard used for mobile communications.

FIG. 1 illustrates an exemplary configuration of an OFDMA (OFDM Access) wireless frame according to the IEEE 802.16e standard. The horizontal axis of FIG. 1 represents the number of an OFDMA symbol (OFDMA symbol number) and represents a time based direction. The vertical axis of FIG. 1 represents the number of a subchannel logical number (subchannel logical number).

The OFDMA frame includes a subframe of a downlink (DL subframe), a subframe of an uplink (UL subframe), a TTG (Transmit/Receive Transition Gap), and an RTG (Receive/Transmit Transition Gap).

Further, the DL subframe includes a Preamble, a FCH (Frame Control Header), a DL-MAP, a UL-MAP, and plural DL bursts. The Preamble of the DL subframe includes a Preamble Symbol pattern required for enabling a mobile station to realize frame synchronization. The FCH includes data regarding a subchannel to be used or data regarding an immediately following DL-MAP. The DL-MAP includes mapping data of a DL burst of a DL subframe. When a mobile station receives this mapping data, the mobile station can identify the UL-MAP and plural DL bursts (#1-#4) by analyzing the mapping data.

The UL-MAP includes mapping data of a UL burst(s) of a UL subframe. By reading the mapping data, the mobile station can identify the UL burst (#1-#5).

A burst is an allocation of a slot of a DL subframe or an UL subframe of a wireless frame in which there are DL user data or control messages bound for a mobile station (MS) or UL user data or control messages received from a MS. The burst is an area including combinations having the same modulation method and the same FEC (Forward Error Correction). The DL MAP/UL MAP designates the combination of the modulation method and the FEC for each burst. Scheduling results of a wireless base station are reported to each mobile station by using the DL MAP and the UL MAP set at the beginning of the DL subframe of each frame.

The preamble of the frame includes a preamble symbol modulated by BPSK (Binary Phase Shift Keying). A termination station detects the beginning of a frame by detecting the preamble symbol. The IEEE 802.16e standard defines 114 different patterns of the preamble symbol. Each pattern has allocated an Index of a base station. A terminal station identifies the index of the base station by demodulating the preamble.

According to a related art example, there is a technology of forming a transmission frame by adding a preamble part including a BPSK modulation signal (see, for example, Japanese Laid-Open Patent Application No. 2003-110499) or a technology of achieving frame synchronization using OFDM signals having a symmetrically structured preamble (see, for example, Japanese Laid-Open Patent Application No. 2001-333041).

However, in a case where a predetermined signal modulated by BPSK is transmitted as an OFDM signal, the related art example is unable to efficiently detect the predetermined signal.

### SUMMARY OF THE INVENTION

The present invention may provide a detecting method and a detecting circuit that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a detecting method and a detecting circuit particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a detecting circuit for receiving an Orthogonal Frequency Division Multiplexing (OFDM) signal modulated by Binary Phase Shift Keying (BPSK) and detecting a predetermined symbol in the OFDM signal, including: a correlation calculating part configured to obtain a correlation value between a first signal in a first part of the OFDM signal and an inverted second signal obtained from a second part of the OFDM signal corresponding to the first part; and a detecting part configured to detect the predetermined symbol based on the correlation value obtained by the correlation calculating part.

Further, another embodiment of the present invention provides a detecting method for receiving an Orthogonal Frequency Division Multiplexing (OFDM) signal modulated by Binary Phase Shift Keying (BPSK) and detecting a predetermined symbol in the OFDM signal, the method including the steps of: a) obtaining a correlation value between a first signal in a first part of the OFDM signal and an inverted second signal obtained from a second part of the OFDM signal corresponding to the first part; and b) detecting the predetermined symbol based on the correlation value obtained in step b).

Other objects and further features of the present invention will be apparent from the following detailed description when read in conjunction with the accompanying drawings.

### BRIEF DESCRIPTION OF THE DRAWINGS

FIG. 1 is a schematic diagram illustrating an exemplary configuration of an OFDMA wireless frame;

FIG. 2 is a diagram illustrating a temporal waveform of a preamble symbol;

FIG. 3 is a schematic diagram of a temporal waveform of a preamble symbol;

FIG. 4 is a schematic diagram depicting an exemplary configuration of a detecting circuit according to a first embodiment of the present invention;

FIG. 5 is a signal timing chart for describing an operation of the detecting circuit of FIG. 4;

FIG. 6 is a schematic diagram depicting an exemplary configuration of a symbol synchronization circuit according to an embodiment of the present invention;

FIG. 7 is a signal timing chart for describing an operation of the symbol synchronization circuit of FIG. 6;

FIG. 8 is a schematic diagram depicting an exemplary configuration of a detecting circuit according to a second embodiment of the present invention;

FIG. 9 is a signal timing chart for describing an operation of the detecting circuit of FIG. 8;

FIG. 10 is a schematic diagram depicting an exemplary configuration of a detecting circuit according to a third embodiment of the present invention;

FIG. 11 is a signal timing chart for describing an operation of the detecting circuit of FIG. 10;

FIG. 12 is a schematic diagram depicting an exemplary configuration of a detecting circuit according to a fourth embodiment of the present invention;

FIG. 13 is a signal timing chart for describing an operation of the detecting circuit of FIG. 12;

FIG. 14 is a schematic diagram depicting an exemplary configuration of a frame adding circuit according to an embodiment of the present invention; and

FIG. 15 is a signal timing chart for describing an operation of the frame adding circuit of FIG. 14.

### DESCRIPTION OF THE PREFERRED EMBODIMENTS

In the following, embodiments of the present invention will be described with reference to the accompanying drawings.

The below-described embodiments of detecting circuits are for detecting a transmitted predetermined signal modulated by BPSK. The predetermined signal is, for example, a preamble signal of WiMAX). It is, however, to be noted that the detecting circuits according to the below-described embodiments of the present invention may detect other signals used in other communications systems.

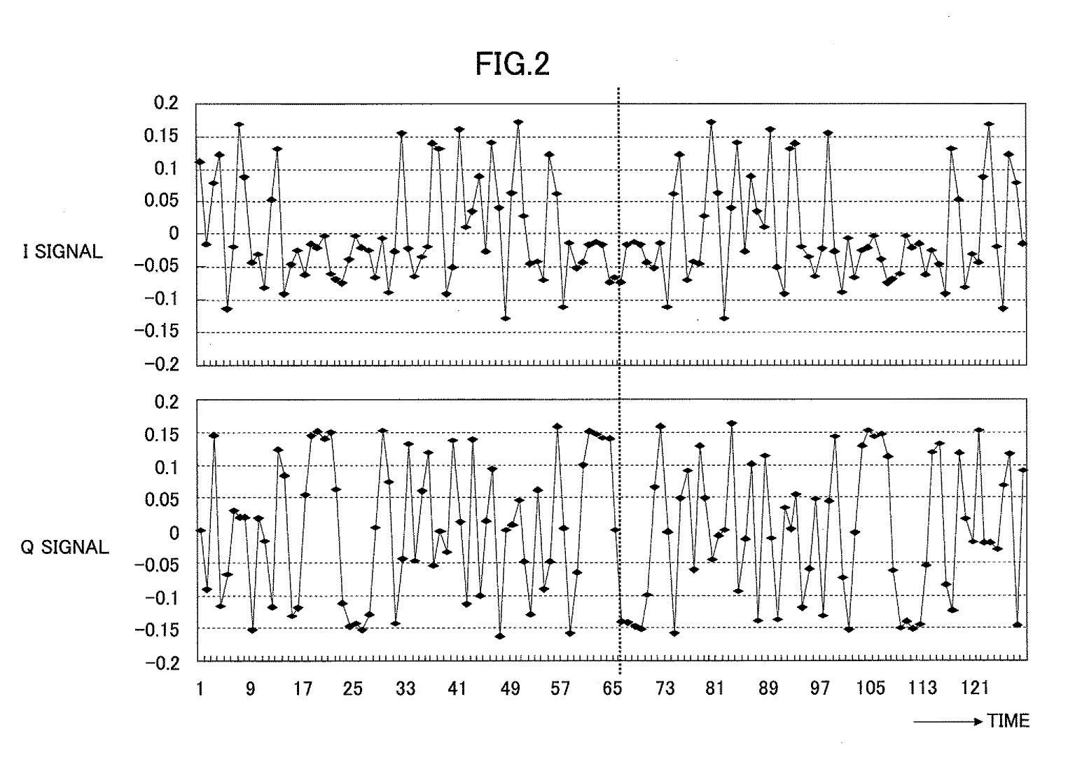

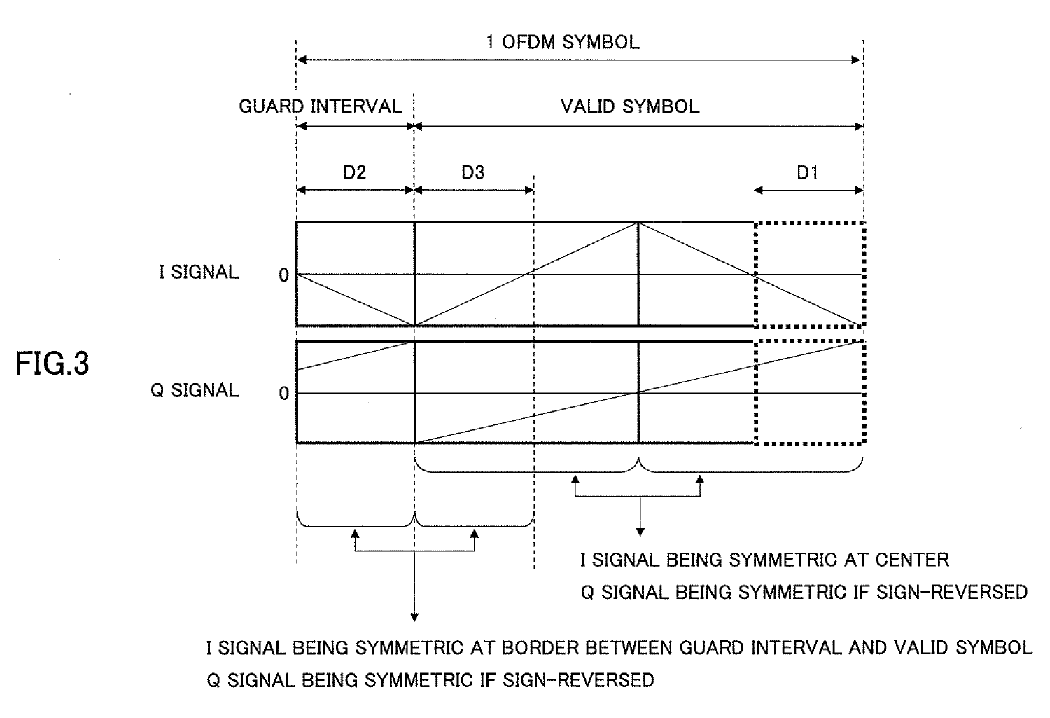

In a case where a predetermined signal (in this example, a preamble signal) modulated by BPSK is transmitted as an OFDM signal, the inventor of the present invention has found the existence of a symmetrical characteristic by analyzing a temporal waveform of a preamble symbol of the preamble signal. FIG. 2 illustrates a temporal waveform of a preamble symbol. FIG. 3 schematically illustrates a temporal waveform of a preamble symbol. In this example, an I (In-phase) signal is symmetrical with respect to a temporal center of a valid symbol, and a Q (Quadrature-phase) signal is symmetrical by sign-reversing a temporal center of a valid symbol.

In this example, a single OFDM symbol includes a guard interval and a valid symbol. In FIG. 3, the guard interval corresponds to a CP (Cyclic Prefix) part D2 which is a copy (duplicate) of an end part (last part) D1 of the valid symbol. Further, part D3 of FIG. 3 beginning at the start of the valid symbol is equivalent to the CP part D2. As illustrated in FIG. 3, the I signal is symmetrical where the start of the valid symbol is the center. As illustrated in FIG. 3, the Q signal is sign-reversed symmetrical where the start of the valid symbol is the center.

Accordingly, a preamble can be detected by utilizing the symmetry of the OFDM signal waveform modulated by using BPSK.

In other words, a predetermined symbol can be detected by using a detecting circuit for receiving an Orthogonal Frequency Division Multiplexing (OFDM) signal modulated by Binary Phase Shift Keying (BPSK) and detecting a predetermined symbol in the OFDM signal, which circuit includes a correlation calculating part configured to obtain a correlation value between a first part of the OFDM signal and an inverted signal obtained by a second part of the OFDM signal corresponding to the first part and a detecting part configured to detect the predetermined symbol based on the correlation value obtained by the correlation calculating part.

The symmetrical relationships illustrated in FIG. 3 show that a correlation higher than a predetermined criterion can be obtained by calculating, for example, a correlation value between a signal corresponding to the D3 part and a signal corresponding to the D1 part.

Accordingly, by obtaining a correlation value between a signal corresponding to a first part of the OFDM signal (e.g., D3 of FIG. 3) and an inverted (sign-reversed) signal corresponding to a second part of the OFDM signal (e.g., D1 of FIG. 3), a preamble symbol can be detected because a high correlation value can be obtained only when a preamble symbol is received. In other cases where a signal modulated by methods other than BPSK (e.g., QPSK, QAM) is received, such a high correlation value cannot be obtained. Thus, it can be determined whether a received signal is a predetermined signal by referring to the correlation value.

In FIG. 3, other parts of the OFDM signal besides the part D3 and the part D1 may be used for obtaining the correlation value. In one example, parts D2 and D3 may be used to obtain the correlation value. In another example, two symmetrical parts where the center (mid-point) of a valid symbol is the center may be used to obtain the correlation value. With respect to a Q signal, one of the first and second parts may have its sign-reversed for obtaining the correlation value.

Alternatively, other than using parts of a single symbol of an OFDM signal (e.g., part D1 and part D3), an entire single symbol may be used as a part of an OFDM signal. That is, each of the first part and the second part may be substantially equivalent to an entire valid symbol period of an OFDM symbol period.

### First Embodiment

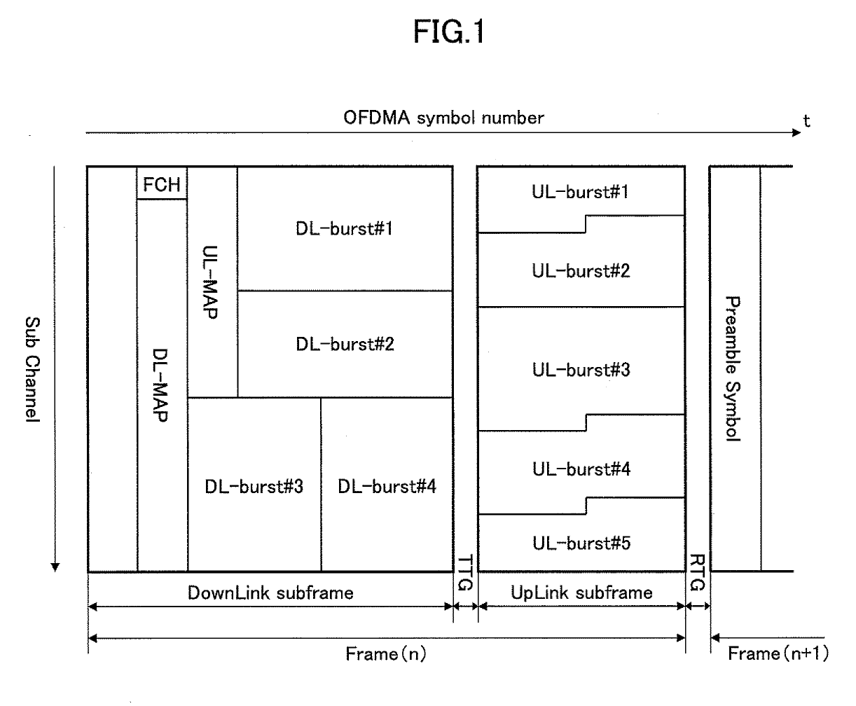

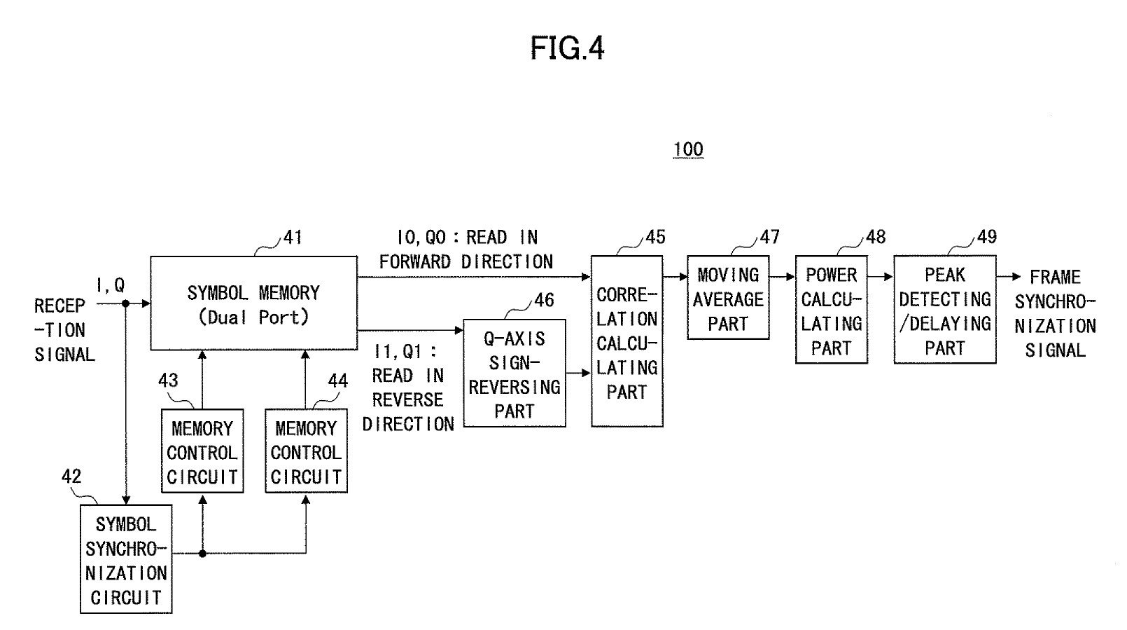

In FIG. 4, a detecting circuit 100 according to a first embodiment of the present invention receives reception signals I, Q configured as OFDM signals. The reception signals I and Q are stored in a symbol memory 41 including a dual port having a capacity capable of storing reception signals of a single symbol period (1 symbol period). The reception signal is a signal obtained by performing IFFT (Inverse Fast Fourier Transform) on the frame configuration illustrated in FIG. 1. The reception signals I, Q are also supplied to a symbol synchronization circuit (symbol synchronization part) 42. The symbol synchronization circuit 42 is configured to detect a start of a valid symbol of an OFDM signal (i.e. symbol synchronization position) and supply a symbol synchronization signal to memory control circuits 43, 44 when detecting the symbol synchronization position.

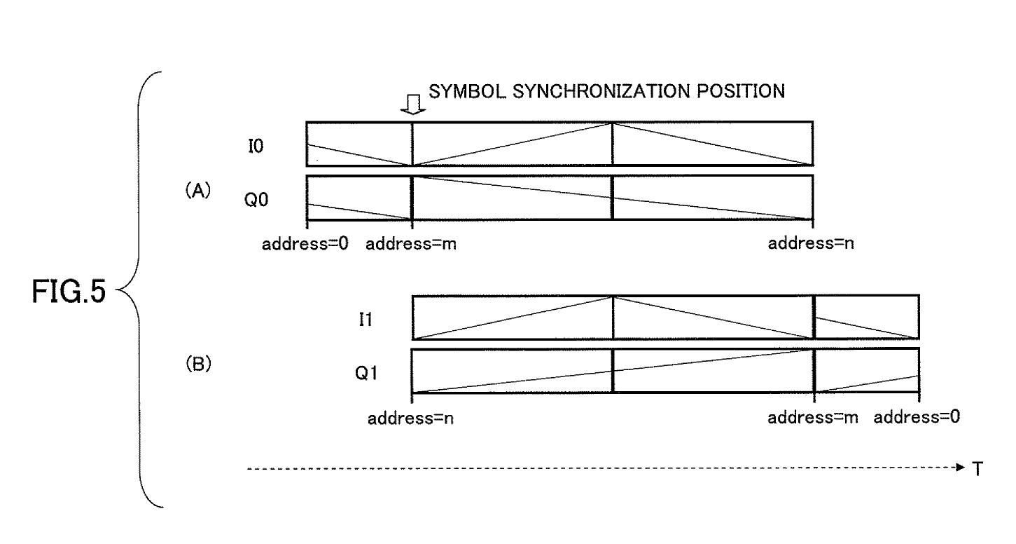

After the reception signals of a single symbol period are recorded (stored) in the symbol memory 41, the memory control circuit 43, which can determine the start of the valid symbol based on the symbol synchronization signal, reads reception signals (I0, Q0) stored in the symbol memory 41 in the same order (t=m, m+1, m+2, . . . , n) as the reception signals are recorded to the symbol memory 41 starting from the start of the valid signal (symbol synchronization position). It is to be noted that “t” represents time and “m” represents an address of a reception signal stored in the symbol memory 41. Then, the memory control circuit 43 outputs the read receptions signals from its port A in a manner illustrated in (A) of FIG. 5. The reception signals (I0, Q0) are supplied to a correlation calculating part 45.

At the same in which the above-described processes are performed by the memory control circuit 43, the memory control circuit 44 reads reception signals (I1, Q1) stored in the symbol memory 41 in an order (t=n, n−1, n−2, . . . , m) opposite to that of recording the reception signals in the symbol memory 41 starting from the end of the valid symbol based on the symbol synchronization position. Then, the memory control circuit 44 outputs the read receptions signals from its port B. The read reception signals (I1, Q1) are supplied to a Q-axis sign-reversing part 46. The Q-axis sign-reversing part 46 reverses only the sign of the Q-axis signal (Q1) but does not reverse the sign of the I-axis signal. Then, the Q-axis reversing part 46 supplies the sign-reversed Q-axis signal to the correlation calculating part 45.

The correlation calculating part 45 uses the following Formulas (1) and (2) to obtain correlation values CI, CQ from the reception signals I0, Q0 indicative of addresses from the start of the valid symbol to the end of the valid symbol and the reception signals I1, Q1 indicative of addresses from the end of the valid symbol to the start of the valid symbol as shown in (A) and (B) of FIG. 5. Thereby, a high level correlation value output from the correlation calculating part 45 can be obtained in a symbol period of the preamble of a single frame.

[Formula (1)]

CI=I0×I1+Q0×Q1

[Formula (2)]

CQ=I1×Q0−I0×Q1

Then, a moving average part 47 uses the following Formulas (3) and (4) to obtain moving averages M1, MQ from the output of the correlation calculating part 45 in a single valid symbol period. Then, a power calculating part 48 uses the following Formula (5) to obtain a power value POW of the moving averages obtained by the moving average part 47, to thereby output a correlation power value.

$$\begin{matrix}[ Formula ( 3 ) ] & \\ MI = \frac{1}{N} {\sum }_{n = 0}^{N - 1} CI & ( 3 ) \\ [ Formula ( 4 ) ] & \\ MQ = \frac{1}{N} {\sum }_{n = 0}^{N - 1} CQ & ( 4 )\end{matrix}$$

“N” indicates number of samples in a period from which a moving average is obtained.

[Formula (5)]

POW=\sqrt{CI²+CQ²} (5)

It is to be noted that, in Formulas (3) and (4), relationships “L=m−n” and “m<n” are satisfied.

Then, a peak detecting/delaying part 49 determines that a preamble symbol is received by detecting a correlation power value greater than a predetermined criterion (e.g., maximum correlation power value) and outputs a frame synchronization signal indicating the start of a frame. More preferably, upon the detection, the peak detecting/delaying part 49 delays the position of the preamble symbol for a period of “(one symbol period)−(process delay time)” and outputs a frame synchronization signal indicating the start of a frame.

With the detecting circuit 100 according to the first embodiment of the present invention, a predetermined signal can be efficiently detected. Further, the detecting circuit 100 requires no frame memory having large storage capacity. Further, since a moving average for only a single valid symbol period needs to be calculated in this embodiment, the dynamic range of the moving average part 47 can be reduced compared to a conventional example. Further, since the detecting circuit 100 according to this embodiment requires no pattern matching, the detecting circuit 100 does not need to be accommodated with plural circuits and does not need to operate at high speed. Therefore, the circuit scale of the detecting circuit 100 and power consumption can be reduced.

<Symbol Synchronizing Circuit>

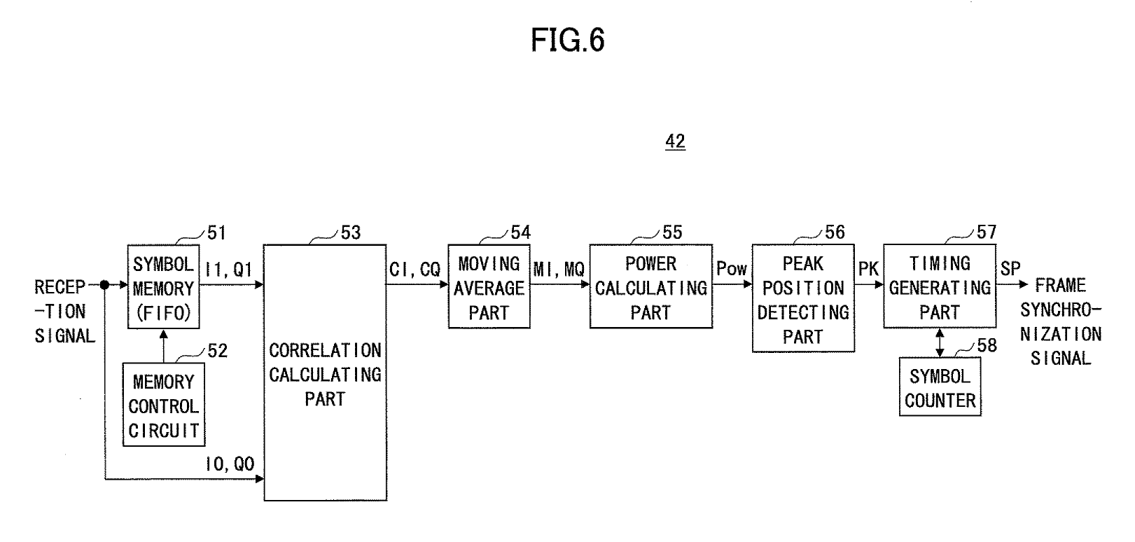

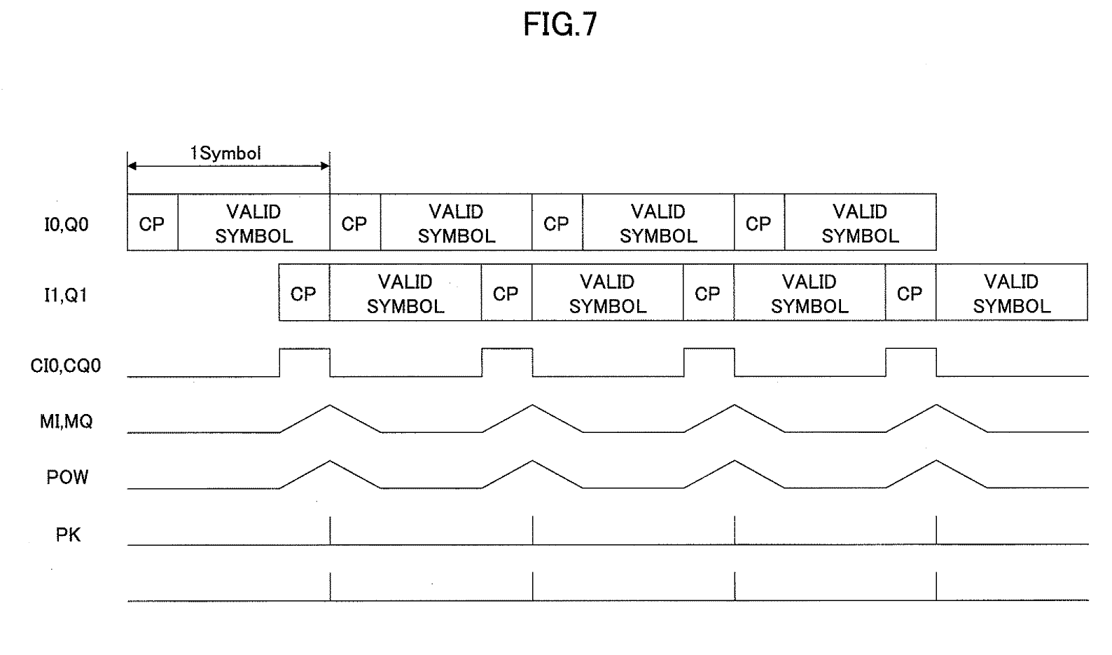

FIG. 6 illustrates a circuit configuration of the symbol synchronization circuit 42 used in the detecting circuit 100 according to the first embodiment of the present invention. FIG. 7 illustrates a signal timing chart for describing an operation of the symbol synchronization circuit 42 of FIG. 6.

In FIG. 6, reception signals are stored in a symbol memory 51 (e.g., FIFO (First-In First-Out memory). A memory control circuit 52 reads the stored reception signals after a delay equivalent to a single valid symbol period and supplies the read signals I1, Q1 to a correlation calculating part 53. At substantially the same time of supplying the signals I1, Q1 to the correlation calculating part 53, reception signals I0, Q0 are supplied to the correlation calculating part 53.

The correlation calculating part 53 uses the Formulas (1) and (2) to obtain a correlation value CI, CQ from the reception signals I0, Q0 and the signals I1, Q1. As illustrated in FIG. 3, the correlation calculating part 53 outputs a high level correlation value only at a guard interval period in a single symbol because the guard interval D2 is a copy of the last part D1 of a valid symbol.

Then, a moving average part uses the Formulas (3) and (4) to obtain moving averages MI, MQ in a single symbol period from the output of the correlation calculating part 53. Then, a power calculating part 55 uses the Formula (5) to obtain a power value POW from the moving averages MI, MQ. Then, a peak position calculating part 56 detects a peak position of the power value POW output from the power calculating part 55 and outputs the detected peak position to a timing generating part 57.

Since the timing indicating the peak position of the power value is liable to change due to, for example, noise, a timing generating part 57, which repeats counting single symbol periods, is provided in the symbol synchronization circuit 42. Accordingly, the timing generating part 57 outputs a symbol synchronization signal in synchronization with the peak position by referring to the counted value of the timing generating part 57. Thereby, even where a change of timing occurs, the timing generating part 57 can output a symbol synchronization signal at an appropriate timing.

### Second Embodiment

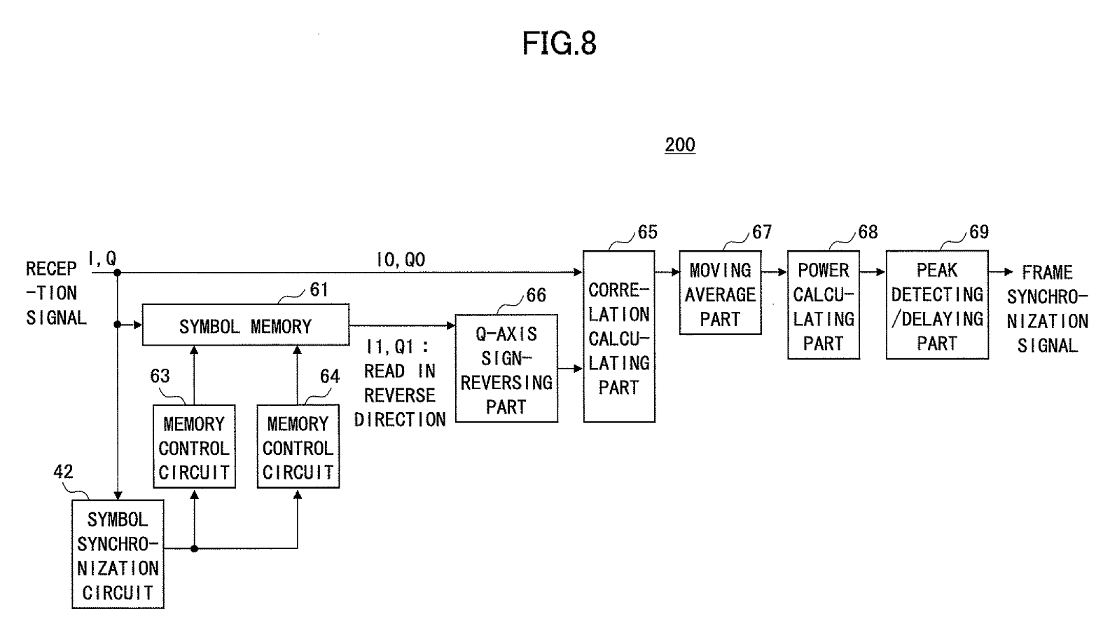

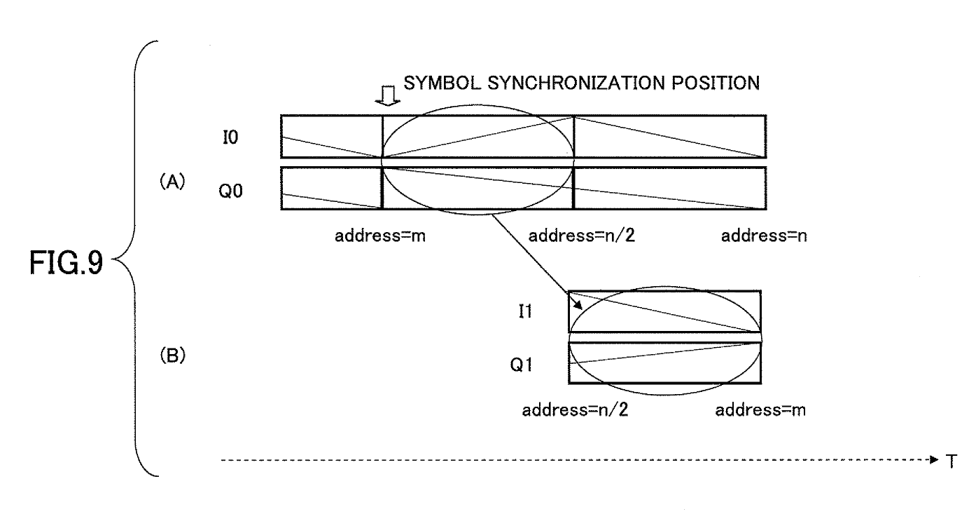

FIG. 8 illustrates a circuit configuration of a detecting circuit 200 according to a second embodiment of the present invention. FIG. 9 is a signal timing chart for describing an operation of the detecting circuit 200 of FIG. 8. In FIG. 8, like components are indicated with reference numerals similar to those of FIG. 4.

In FIG. 8, reception signals I, Q are stored in a symbol memory 61 having a capacity capable of storing reception signals of half a symbol period (1/2 symbol period). The reception signals I, Q are also supplied to the symbol synchronization circuit 42. Further, the reception signals are supplied to a correlation calculating part 65 in the form of reception signals I0, Q0. The symbol synchronization circuit 42 is configured to detect the start of a valid symbol of an OFDM signal (i.e. symbol synchronization position) and supply a symbol synchronization signal to a writing-purpose memory control circuit 63 and a reading-purpose memory control circuit 64 when detecting the symbol synchronization position.

Since the writing-purpose memory control circuit 63 can determine the start of a valid symbol based on the symbol synchronization symbol, the writing-purpose memory control circuit 63 writes (records) reception signals of half a valid symbol period in the symbol memory 61 beginning at the start “m” of the valid symbol by incrementing the address of the reception signals (t=m, m+1, m+2, . . . , n/2) as shown in (A) of FIG. 9. After reception signals of half a symbol period are recorded to the symbol memory 61, the reading-purpose memory control circuit 64 reads reception signals of half a valid symbol period from the symbol memory 61 beginning from a temporal center (mid-point) n/2 of a valid symbol by decrementing the address of the reception signals (t=n/2, n/2−1, n/2−2, . . . , m) as shown in (B) of FIG. 9 during a period where half a valid symbol worth's of reception signals are being supplied from the temporal center n/2 of the valid symbol to an end n of the valid symbol. In other words, the value of the last address of the reception signal written by the writing-purpose memory control circuit 63 (last address after writing half a valid symbol worth's of reception signals) is the initial value for the reading-purpose memory control circuit 64 to begin decrementing the address of the reception signals. Accordingly, the writing-purpose memory control circuit 63 reads reception signals in the opposite order with respect to the writing order. That is, the writing-purpose memory control circuit 63 reads reception signals symmetrically where the temporal center of the valid symbol is the center. Then, the read reception signals (I1, Q1) are supplied to a Q-axis sign-reversing part 66. The Q-axis sign-reversing part 66 reverses only the sign of the Q-axis signals (Q1) but does not reverse the sign of the I-axis signals. Then, the Q-axis reversing part 66 supplies the sign-reversed Q-axis signals to the correlation calculating part 65.

The correlation calculating part 65 uses the Formulas (1) and (2) to obtain correlation values CI, CQ from reception signals I0, Q0 (reception signals corresponding to those running from the temporal center of the valid symbol to the end of the valid symbol) as shown in (A) of FIG. 9, reception signals I1 (read reception signals corresponding to those running from the temporal center of the valid symbol to the start of the valid symbol) and reception signals Q1 (sign-reversed read reception signals) as shown in (B) of FIG. 9. Thereby, the correlation calculating part 65 outputs a high level correlation value only at a ½ symbol period of a preamble of a single frame.

Then, a moving average part 67 uses the Formulas (3) and (4) to obtain moving averages MI, MQ in a ½ symbol period from the output of the correlation calculating part 65. Then, a power calculating part 68 uses the Formula (5) to obtain a power value POW of the moving averages obtained by the moving average part 67, to thereby output a correlation power value. It is to be noted that, in Formulas (3) and (4), relationships “L=n/2−m” and “m<n” are satisfied.

Then, a peak detecting/delaying part 69 determines that a preamble symbol is received by detecting a correlation power value greater than a predetermined criterion (e.g., maximum correlation power value) and outputs a frame synchronization signal indicating the start of a frame.

Hence, the detecting circuit 200 of the second embodiment can further reduce the dynamic range of the moving average part 67 since only the moving average in half a valid symbol period needs to be calculated. Although the symbol memory 61 described in the second embodiment uses a single port, the symbol memory 61 may be configured as a dual port memory. Further, the symbol memory 61 may be shared with the symbol memory 51 in the symbol synchronization circuit 42. In the second embodiment, because correlation values of reception signals located symmetrically with respect to the temporal center of the valid symbol are obtained, there is no need to store reception signals for a ½ valid symbol period (half a valid symbol period) in the symbol memory 61. For example, a frame synchronization signal can be appropriately output even in a case of storing reception signals for a ¼ valid symbol period, a ⅛ valid symbol period, or a 1/16 valid symbol period.

### Third Embodiment

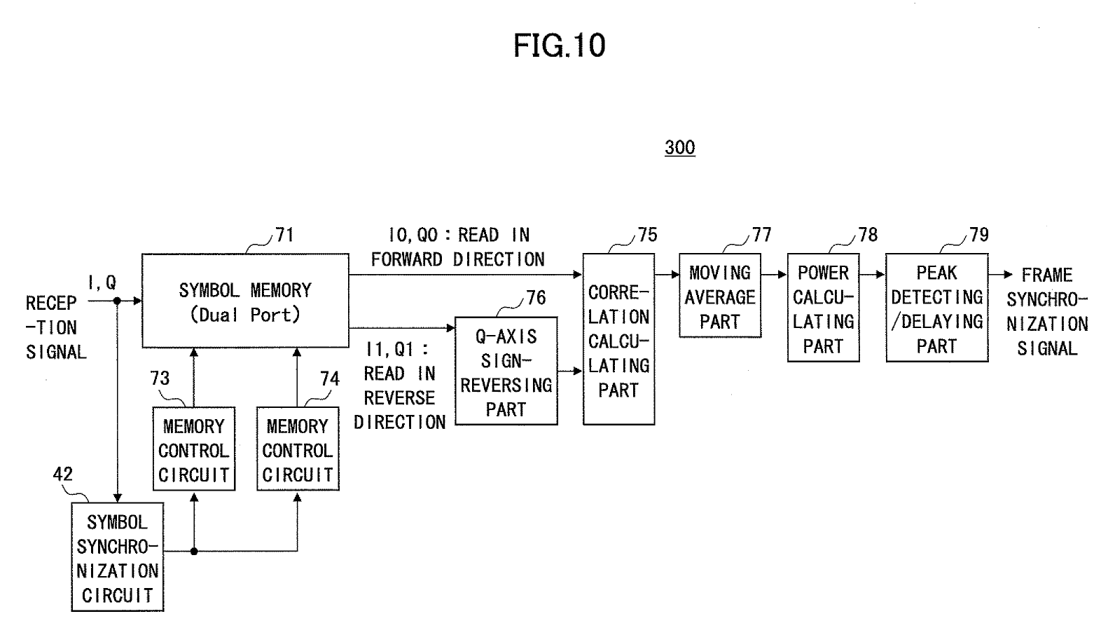

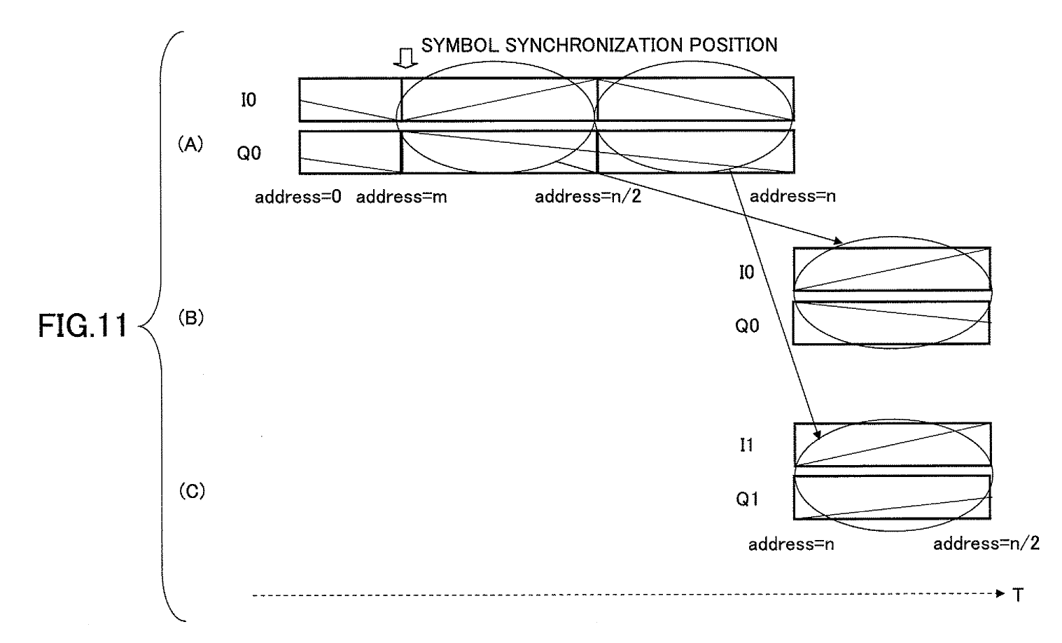

FIG. 10 illustrates a circuit configuration of a detecting circuit 300 according to a third embodiment of the present invention. FIG. 11 is a signal timing chart for describing an operation of the detecting circuit 300 of FIG. 10. In FIG. 10, like components are described with like reference numerals as of FIG. 4.

In FIG. 10, reception signals I, Q are stored in a symbol memory 71 having a capacity capable of storing reception signals of a single symbol period (1 symbol period). The reception signals I, Q are also supplied to the symbol synchronization circuit 42. The symbol synchronization circuit 42 is configured to detect a start of a valid symbol of an OFDM signal (i.e. symbol synchronization position) and supply a symbol synchronization signal to a memory control circuit 73 including port A and a memory control circuit 74 including port B when detecting the symbol synchronization position.

Since the memory control circuit 73 can determine the start of a valid symbol based on the symbol synchronization symbol, the memory control circuit 73 or the memory control circuit 74 writes (records) reception signals of a single valid symbol period to the symbol memory 71 beginning at the start “m” of the valid symbol by incrementing the address of the reception signals (t=m, m+1, m+2, . . . , n/2) as shown in (A) of FIG. 11. After reception signals of a single symbol period are recorded to the symbol memory 71, the memory control circuit 73 reads reception signals of half a valid symbol period from the symbol memory 71 beginning from the start m of the valid symbol to a temporal center (mid-point) n/2 of a valid symbol in the same order as writing (recording) reception signals to the symbol memory 71 (t=m, m+1, m+2, . . . , n/2) and outputs the read reception signals (I0, Q0) from port A as shown in (B) of FIG. 11. The read reception signals (I0, Q0) are output to a correlation calculating part 75. At substantially the same time where reception signals are read by the memory control circuit 73, the memory control circuit 74 reads reception signals of half a valid symbol period from the symbol memory 71 beginning from an end n of the valid symbol to the temporal center n/2 of the valid symbol in the opposite order with respect to the writing order (t=n, n−1, n−2, . . . , n/2−1) and outputs the read reception signals (I1, Q1) from port B as shown in (C) of FIG. 11. Then, the read reception signals (I1, Q1) are supplied to a Q-axis sign-reversing part 76. The Q-axis sign-reversing part 76 reverses only the sign of the Q-axis signals (Q1) but does not reverse the sign of the I-axis signals. Then, the Q-axis reversing part 76 supplies the sign-reversed Q-axis signals to the correlation calculating part 75.

The correlation calculating part 75 uses the Formulas (1) and (2) to obtain correlation values CI, CQ from reception signals I0, Q0 (reception signals corresponding to those running from the start of the valid symbol to the temporal center of the valid symbol) as shown in (B) of FIG. 11, reception signals I1 (read reception signals corresponding to those running from the end of the valid symbol to the temporal center of the valid symbol) and reception signals Q1 (sign-reversed read reception signals) as shown in (C) of FIG. 11. Thereby, the correlation calculating part 75 outputs a high level correlation value only at a ½ symbol period of a preamble of a single frame.

Then, a moving average part 77 uses the Formulas (3) and (4) to obtain moving averages MI, MQ in a ½ symbol period from the output of the correlation calculating part 75. Then, a power calculating part 78 uses the Formula (5) to obtain a power value POW of the moving averages obtained by the moving average part 77, to thereby output a correlation power value. It is to be noted that, in Formulas (3) and (4), relationships “L=n/2−m” and “m<n” are satisfied.

Then, a peak detecting/delaying part 79 determines that a preamble symbol is received by detecting a correlation power value greater than a predetermined criterion (e.g., maximum correlation power value) and outputs a frame synchronization signal indicating the start of a frame.

Hence, the detecting circuit 300 of the third embodiment can further reduce the dynamic range of the moving average part 77 since only the moving average in half a valid symbol period needs to be calculated. In the third embodiment, because correlation values of reception signals located symmetrically with respect to the temporal center of the valid symbol are obtained, there is no need to store reception signals for a ½ valid symbol period (half a valid symbol period) in the symbol memory 71. For example, a frame synchronization signal can be appropriately output even in a case of storing reception signals for a ¼ valid symbol period, a ⅛ valid symbol period, or a 1/16 valid symbol period.

### Fourth Embodiment

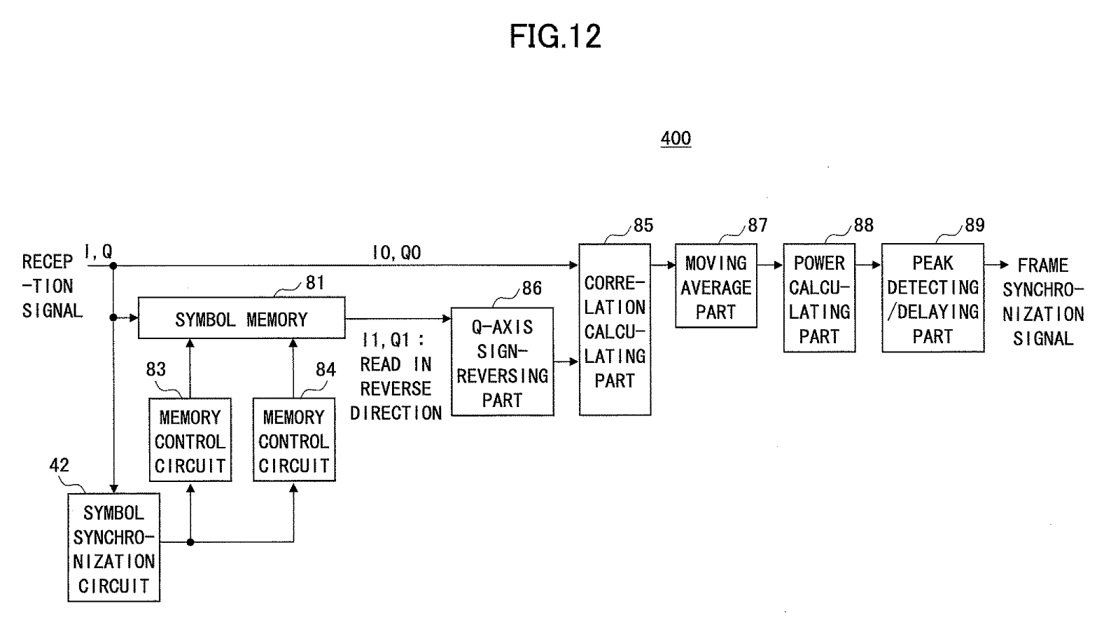

FIG. 12 illustrates a circuit configuration of a detecting circuit 400 according to a fourth embodiment of the present invention. FIG. 12 is a signal timing chart for describing an operation of the detecting circuit 400 of FIG. 12. In FIG. 12, like components are described with like reference numerals as of FIG. 4.

In FIG. 12, reception signals I, Q are stored in a single port symbol memory 81 having a capacity capable of storing reception signals of a 1/M symbol period. It is to be noted that, in the fourth embodiment, the guard interval exists only during the 1/M symbol period (e.g., M=8). The reception signals I, Q are also supplied to the symbol synchronization circuit 42. Further, the reception signals are also supplied to a correlation calculating part 85 in the form of reception signals I0, Q0. The symbol synchronization circuit 42 is configured to detect a start of a valid symbol of an OFDM signal (i.e. symbol synchronization position) and supply a symbol synchronization signal to a writing-purpose memory control circuit 83 and a reading-purpose memory control circuit 84 when detecting the symbol synchronization position.

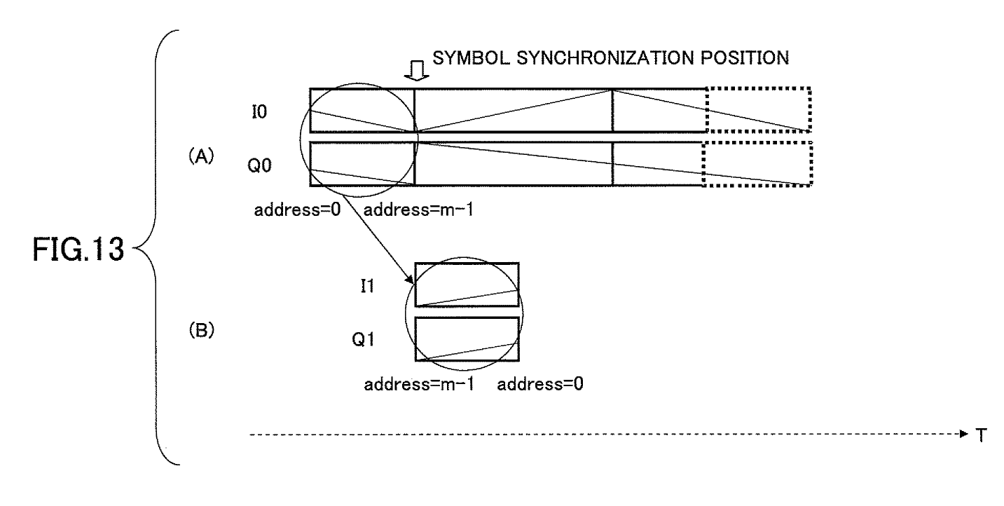

Since the writing-purpose memory control circuit 83 can determine the start of a valid symbol based on the symbol synchronization symbol, the writing-purpose memory control circuit 83 writes (records) reception signals of a guard interval period (period provided in front of (before) a valid symbol) in the symbol memory 81 beginning at address 0 by incrementing the address of the reception signals (t=0, 0+1, 0+2, . . . , m−1) as shown in (A) of FIG. 13. After reception signals of 1/M symbol period are recorded to the symbol memory 81, the reading-purpose memory control circuit 84 reads reception signals of 1/M valid symbol period from the symbol memory 81 beginning from an end of the guard interval period to the start of the guard interval period by decrementing the address of the reception signals (t=m−1, m−2, . . . , 0) as shown in (B) of FIG. 13. In other words, the value of the last address of the reception signal written by the writing-purpose memory control circuit 83 (last address after writing 1/M valid symbol worth's of reception signals) is the initial value for the reading-purpose memory control circuit 84 to begin decrementing the address of the reception signals. Accordingly, the writing-purpose memory control circuit 83 reads reception signals in the opposite order with respect to the writing order. That is, the writing-purpose memory control circuit 83 reads reception signals symmetrically where the start of the valid symbol is the center. Then, the read reception signals (I1, Q1) are supplied to a Q-axis sign-reversing part 86. The Q-axis sign-reversing part 86 reverses only the sign of the Q-axis signals (Q1) but does not reverse the sign of the I-axis signals. Then, the Q-axis reversing part 86 supplies the sign-reversed Q-axis signals to the correlation calculating part 85.

The correlation calculating part 85 uses the Formulas (1) and (2) to obtain correlation values CI, CQ from a guard interval worth's of reception signals I0, Q0 (reception signals corresponding to those running from the start of the valid symbol to the temporal center of the valid symbol) as shown in (A) of FIG. 13, reception signals I1 (read reception signals corresponding to those running from the start of the valid symbol to the start of the guard interval) and reception signals Q1 (sign-reversed read reception signals) as shown in (B) of FIG. 13. Thereby, the correlation calculating part 85 outputs a high level correlation value only at a guard interval period of a preamble of a single frame.

Then, a moving average part 87 uses the Formulas (3) and (4) to obtain moving averages MI, MQ in a 1/M symbol period from the output of the correlation calculating part 85. Then, a power calculating part 88 uses the Formula (5) to obtain a power value POW of the moving averages obtained by the moving average part 87, to thereby output a correlation power value. It is to be noted that, in Formulas (3) and (4), relationships “L=m−1” and “m<0” are satisfied.

Then, a peak detecting/delaying part 89 determines that a preamble symbol is received by detecting a correlation power value greater than a predetermined criterion (e.g., maximum correlation power value) and outputs a frame synchronization signal indicating the start of a frame. More preferably, upon the detection, the peak detecting/delaying part 89 delays the position of the preamble symbol for a period of “(one valid symbol period)−(one guard interval period)—(process delay time)” and outputs a frame synchronization signal indicating the start of a frame.

Hence, the detecting circuit 400 of the fourth embodiment can further reduce the dynamic range of the moving average part 87 since only the moving average in a 1/M valid symbol period needs to be calculated. Although the symbol memory 81 described in the fourth embodiment uses a single port, the symbol memory 81 may be configured as a dual port memory. Further, the symbol memory 81 may be shared with the symbol memory 51 in the symbol synchronization circuit 42. In the fourth embodiment, because correlation values of reception signals located symmetrically with respect to the start of the valid symbol are obtained, there is no need to store reception signals for a 1/M valid symbol period in the symbol memory 81. For example, a frame synchronization signal can be appropriately output even in a case of storing reception signals for a 1/16 valid symbol period.

<Frame Addition>

In an atmosphere where there is large amount of noise, peak detection cannot be accurately conducted due to the correlation power value being buried in the noise. In this case, frame addition may be performed on the correlation power value output from the power calculating part 48, 68, 78, 88 as described below.

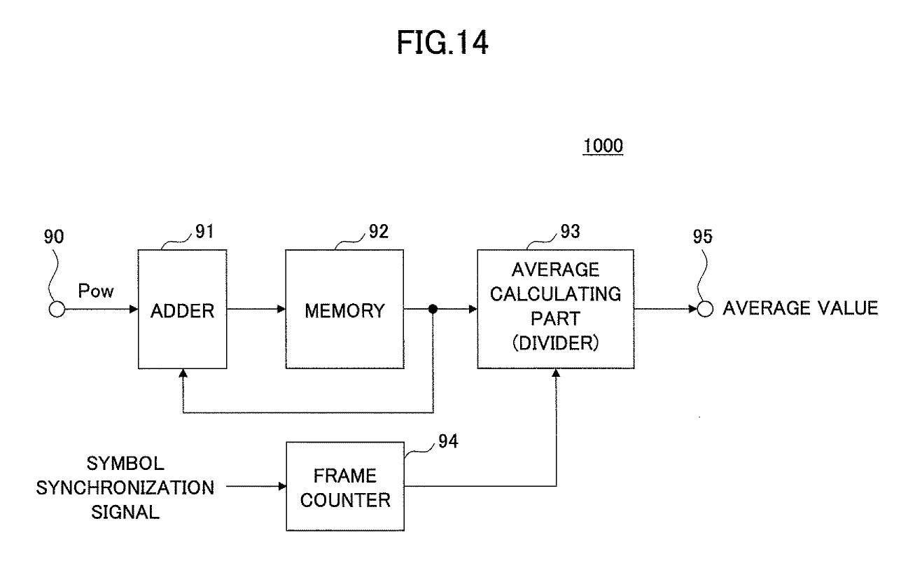

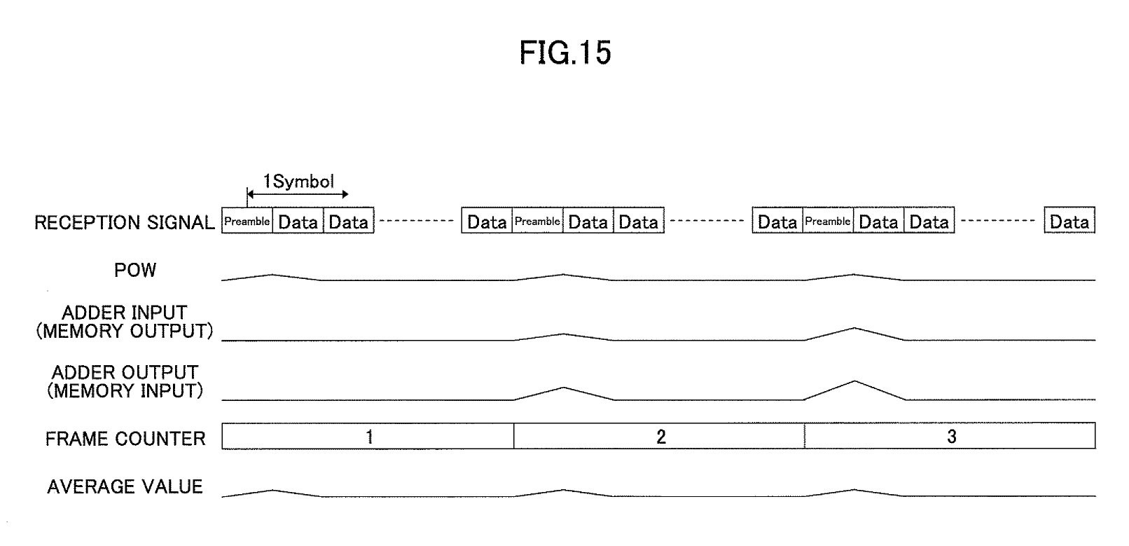

FIG. 14 is a circuit diagram of a frame adding circuit 1000 according to an embodiment of the present invention. FIG. 15 is a signal timing chart for describing an operation of the frame adding circuit 1000 of FIG. 14.

In FIG. 14, a correlation power value output from the power calculating part 48, 68, 78, 88 is input to a terminal 90. Then, the terminal 90 supplies the input correlation power value to an adder 91. The adder (accumulating part) 91 adds the correlation power value from the terminal 90 to a correlation power cumulative value output from a memory 92 and writes the addition result (correlation power cumulative value) to the memory 92. Further, the correlative power cumulative value output from the memory 92 is supplied to an average calculating part 93.

A symbol synchronization signal is supplied from the symbol synchronization circuit 42 to a frame counter 94. The frame counter 94 counts the number of frames by counting the number of symbol synchronization signals from the symbol synchronization circuit 42. Then, the frame counter 94 supplies the value of the counted frames (frame count value) to an average calculating part 93.

The average calculating part (also referred to as “average part” or “divider”) 93 obtains a correlation power average value by dividing the correlation power cumulative value output from the memory 92 with the frame count value supplied from the frame counter 94. The correlation power average value obtained by the average calculating part 93 is output to a terminal 95. Then, the terminal 95 supplies the correlation power average value to the peak detecting/delaying part 49, 69, 79, 89.

With the above-described frame adding circuit 1000, peak detection can be prevented from being affected by noise. Thereby, the above-described embodiments of the detection circuit 100, 200, 300, 400 can accurately conduct peak detection. Alternatively, the frame adding circuit 1000 may output the correlation power cumulative value output from the adder 91 instead of the correlation power average value. In this case, the average calculating part 93 and the frame counter 94 may be omitted.

Further, the present invention is not limited to these embodiments, but various variations and modifications may be made without departing from the scope of the present invention.

The present application is based on Japanese Priority Application No. 2008-056436 filed on Mar. 6, 2008, with the Japanese Patent Office, the entire contents of which are hereby incorporated by reference.

What is claimed is:

1. A detecting circuit for receiving an Orthogonal Frequency Division Multiplexing (OFDM) signal modulated by Binary Phase Shift Keying (BPSK) and detecting a predetermined symbol in the OFDM signal, comprising:
a correlation calculating part configured to obtain a correlation value between a first signal in a first part of the OFDM signal and an inverted second signal obtained from a second part of the OFDM signal corresponding to the first part; and
a detecting part configured to detect the predetermined symbol based on the correlation value obtained by the correlation calculating part.

2. The detecting circuit as claimed in claim 1, further comprising:
a symbol synchronization part configured to detect a symbol synchronization position in an OFDM symbol period of the OFDM signal and supply a symbol synchronization signal to the correlation calculating part when detecting the symbol synchronization position, wherein the OFDM symbol period includes a valid symbol period.

3. The detecting circuit as claimed in claim 2, wherein the first part of the OFDM signal is a start part of the valid symbol period, wherein the second part of the OFDM signal is a last part of the valid symbol period.

4. The detecting circuit as claimed in claim 2, wherein the first part and the second part are symmetrical with respect to a center of the valid symbol period.

5. The detecting circuit as claimed in claim 2, wherein the first part and the second part are symmetrical with respect to a start point of the valid symbol period.

6. The detecting circuit as claimed in claim 2, wherein each of the first part and the second part is equivalent to an entire valid symbol period of the OFDM symbol period.

7. The detecting circuit as claimed in claim 3, wherein the first signal in the first part of the OFDM signal and the inverted second signal of the second part of the OFDM signal include I signals and Q signals, wherein the correlation calculating part is configured to obtain a correlation value between at least one of the I signal and the Q signal of the first signal and at least one of the I signal and the Q signal of the inverted second signal.

8. The detecting circuit as claimed in claim 7, wherein the detecting part includes
a moving average part configured to obtain a moving average of the correlation value obtained by the correlation calculating part,
a power calculating part configured to calculate a correlation power from the moving average obtained by the moving average part, and
a peak detecting part configured to detect a peak of the correlation power calculated by the power calculating part.

9. The detecting circuit as claimed in claim 8, further comprising:
an average part configured to obtain a correlation power average value by averaging the correlation power output from the power calculating part for each frame and supply the correlation power average value to the peak detecting part.

10. The detecting circuit as claimed in claim 8, further comprising:
an accumulating part configured to obtain a correlation power cumulative value by adding the correlation power output from the power calculating part for each frame and supply the correlation power cumulative value to the peak detecting part.

11. A detecting method for receiving an Orthogonal Frequency Division Multiplexing (OFDM) signal modulated by Binary Phase Shift Keying (BPSK) and detecting a predetermined symbol in the OFDM signal, the method comprising the steps of:
a) obtaining a correlation value between a first signal in a first part of the OFDM signal and an inverted second signal obtained from a second part of the OFDM signal corresponding to the first part; and
b) detecting the predetermined symbol based on the correlation value obtained in step b).
